(19) United States
(12) Patent Application Publication
(10) Pub. No.: US 2026/0131345 A1
(43) Pub. Date: May 14, 2026

(54) SPRAYING UNIT WITH PURGE FUNCTION

(71) Applicant: EXEL INDUSTRIES, EPERNAY (FR)

(72) Inventor: Thomas BOUCQUEMONT, Bergères-lès-Vertus (FR)

(73) Assignee: EXEL INDUSTRIES, EPERNAY (FR)

(21) Appl. No.: 19/382,616

(22) Filed: Nov. 7, 2025

(30) Foreign Application Priority Data
Nov. 8, 2024 (FR) 2412263

(51) Int. Cl. B05B 15/55; A01C 23/04; A01M 7/00

(52) U.S. Cl. CPC B05B 15/55; A01C 23/047; A01M 7/0042

(57) ABSTRACT

The present invention aims at a selective liquid spraying unit comprising a liquid inlet, a spraying nozzle, a delivery channel extending from the liquid inlet to the nozzle, possibly through an obstructable passage, and possibly a pneumatically operated valve with a pneumatic chamber delimited by a membrane and supplied by a second pneumatic inlet, a first pneumatic inlet connected to the delivery channel via a check valve, the membrane being movable between a first position causing the obstruction of the obstructable passage and a second position causing the release of said obstructable passage, so that an air supply via the first pneumatic inlet allows the delivery channel and the nozzle to be purged, and a spraying system including one or more spraying units.

### TECHNICAL FIELD

The present invention relates to the field of product spraying systems used in agricultural operations, notably in vineyards or orchards, but also in large-scale farming operations. Said spraying systems are used to apply products, such as phytosanitary products or liquid fertilizers, for example, on a target vegetation.

The target vegetation can be, on the one hand, cereal, protein, or oilseed crops, or on the other hand, tree foliage, shrub foliage, vine foliage, etc.

### BACKGROUND

Spraying systems allow the dispensing of treatment liquid in the form of droplets on the vegetation to be treated.

A farmer usually conducts spraying campaigns on one or more plots of crops, orchards, vineyards. Between two spraying campaigns, it is customary to rinse the elements involved, namely the product tank, the pump, the nozzles, and the various pipelines involved. Rinsing is necessary between two successive campaigns of a given product and even more so when two successive campaigns use two different treatment products that must not be contaminated by a residue of the previous product.

However, a spraying campaign can last several hours with breaks, or even span several days. Moreover, there are cases where rinsing is not done between two campaigns that follow each other in time with a moderate time interval. There remains then liquid product in the various pipelines leading from the pump to the nozzles (indeed, in any circuit there is a “dead” volume that must be rinsed).

In this field, there are spraying systems equipped with so-called ‘drip-stop’ devices with a pneumatically or electrically operated valve that isolates the spray nozzle from the upstream treatment product circuit. In a typical configuration, a pneumatically or electrically operated valve is provided near each nozzle.

When the pneumatically or electrically operated valve is closed, the portion of the pipeline located between the pneumatically (or electrically) operated valve and the nozzle is indeed isolated from the upstream distribution circuit, but liquid remains in this portion of the pipeline.

It is often observed that the nozzle orifice retains a drop, notably by capillary action given the small diameter of the orifice (or orifices).

The presence of this drop (these drops) eventually leads to a deposit of material at each nozzle orifice.

This is all the more pronounced when the treatment liquid is thick and/or viscous. The nozzle orifice can be more or less clogged. The internal surface of the nozzle can also be coated with a deposit that accumulates over time.

This deposit eventually alters the characteristics of the orifice and eventually degrades the quality of the spraying.

This phenomenon requires periodic cleaning of the nozzle orifices. Such periodic cleaning is tedious. Moreover, such cleaning can generate a risk of damaging the nozzle orifice.

There is therefore a need to avoid the presence of such a drop at the nozzle orifice as soon as the spraying is inactive for the nozzle in question. All or part of the nozzles can be deactivated depending on the ongoing spraying scenario and/or the operating circumstances of the system.

### SUMMARY

In this context, the present invention aims, according to a first aspect, at a selective liquid spraying unit comprising a liquid inlet, a spray nozzle, a delivery channel extending from the liquid inlet to the spray nozzle, characterized in that the spraying unit comprises a first pneumatic inlet connected to the delivery channel via a check valve, so that an air supply via the first pneumatic inlet, when the liquid inlet no longer delivers liquid, allows the delivery channel and the nozzle to be purged.

By means of these arrangements, it is possible to purge the internal volume of the nozzle (dead volume) and blow away the drop that may have formed at the nozzle orifice, and thanks to the purging of the delivery channel, another drop is prevented from reforming following vibrational solicitations. Thus, the spraying product does not crystallize in place and the need to clean the nozzle is substantially reduced.

As will be seen in more detail later, several ways of generating an air flow in the first pneumatic inlet are provided.

It should be noted that the check valve allows air to pass from the first pneumatic inlet to the delivery channel but prevents liquid, whether pressurized or not, in the delivery channel from flowing back to the first pneumatic inlet.

It is noted that the valve that selectively authorizes or interrupts the delivery of liquid product can be arranged in the spraying unit or can be arranged remotely from the spraying unit, for example, in a section head serving several spraying units.

Furthermore, according to the invention, the delivery channel extends from the liquid inlet to the spray nozzle through an obstructable passage, and the spraying unit comprises a pneumatically operated valve with a pneumatic chamber delimited by a membrane and supplied with air by a second pneumatic inlet, the membrane being movable between a first position causing the obstruction of the obstructable passage and a second position causing the release of said obstructable passage, so that an air supply via the first pneumatic inlet when the obstructable passage is obstructed allows the delivery channel and the nozzle to be purged. The membrane is preferably flexible.

Such a pneumatically operated valve proves to be reliable and inexpensive. It withstands the physico-chemical constraints and the environment generally encountered by product spraying systems used in agricultural and viticultural operations. It is noted that there is no electricity in the spraying unit.

It is noted that the pneumatically operated valve and the membrane can form a normally closed configuration or a normally open configuration. In the normally closed configuration, energy must be supplied to leave the normally closed state. In the normally open configuration, energy must be supplied to leave the normally open state.

Moreover, it is noted that the obstructable passage is located in the immediate vicinity of the nozzle and consequently the dead volume between the obstructable passage and the nozzle orifice represents a relatively limited volume. The volume to be purged is thus small, the wasted product is minimal, it is not necessary to blow a large volume of air to purge the dead volume of interest and remove the potential drop at the nozzle orifice.

Sometimes in the jargon, the term ‘lung’ is used to designate the pneumatic chamber of the pneumatically operated valve.

According to one embodiment, the pneumatically operated valve is of the normally closed type.

Energy, here pneumatic, must be supplied to open the passage and allow the delivery of product by the corresponding nozzle. This ensures the secure delivery of the treatment product.

According to one embodiment, the pneumatically operated valve is of the normally open type.

This is the reverse logic of the previous one, when the upstream liquid circuit is under pressure, by default spraying occurs, a command must be exercised not to spray. Here we are in an inhibition logic.

According to an alternative embodiment to the pneumatically operated valve, the spraying unit may comprise an electrically operated valve comprising a piston, the piston being movable between a first position causing the obstruction of the obstructable passage and a second position causing the release of said obstructable passage. Thus, the flexibility provided by an electrical command can be benefited from.

According to one embodiment, the spraying unit further comprises a unit body forming a structure on which the nozzle and the pneumatically operated valve are fixed.

As a result, said unit body ensures the cohesion of the unit and the mechanical protection of the components housed in the unit body.

According to one embodiment, the delivery channel is arranged and formed in the unit body.

As a result, the delivery channel is directly integrated into the unit body, which increases the integration of the spraying unit and reduces its cost price because no pipe is then necessary for the delivery channel.

The present invention also aims, according to a second aspect, at a spraying system comprising a plurality of spraying units as described above and at least one pneumatic solenoid valve selectively supplying compressed air to the first pneumatic inlets of the spraying units.

The pneumatic solenoid valve in question allows blowing to occur at the right time after the cessation of liquid spraying by the nozzle. It is a selective command of the air flow entering through the first pneumatic inlet. It is noted that this selective command has a short duration, for example from 0.5 seconds to 2 seconds.

According to one embodiment, the pneumatic solenoid valve is a 3/2 pneumatic solenoid valve with the purge orifice connected to the first pneumatic inlets of the spraying units.

In this case, the pneumatic solenoid valve that commands the pneumatically operated valve is exploited, and a volume of compressed air that is to be evacuated at the time of spraying interruption is exploited, said volume of air being redirected (or diverted) to the first pneumatic inlet of the spraying unit.

In this case, the pneumatically operated valve is of the normally closed type. This will be detailed later with reference to FIG. 4.

According to one embodiment, the pneumatic solenoid valve is a specific pneumatic solenoid valve. This forms a flexible and adaptable command that can respond to several predefined logics, for example, the blowing time can be parameterizable.

In practice, it is a specific pneumatic solenoid valve for purging, distinct from the one that commands the lung. This will be detailed later with reference to FIGS. 5 and 6.

According to one embodiment, the spraying system may comprise several spraying units functionally arranged in parallel by groups or subsets. These groups or subsets can be commanded independently of each other.

According to one embodiment, the spraying system may comprise at least one delivery valve for the treatment product. This valve can be commanded by a control unit that is also responsible for controlling the aforementioned pneumatic or electrical valves, in order to control the delivery of the treatment product and the pneumatic pipelines associated with it in a synchronized and coherent manner.

According to a first possibility, the liquid product delivery valve can be a main valve arranged remotely from the spraying unit, without a local stop valve inside the spraying unit. In a second possibility, the liquid product delivery valve is located inside the spraying unit and can be complemented (or not) upstream by a collective command valve of a system section.

According to one embodiment, a delivery valve for the treatment product is provided by group or subset. For each group or subset, the control unit manages both the delivery of the liquid and the activation of the pneumatic commands.

### BRIEF DESCRIPTION OF THE FIGURES

The invention will be better understood by reading the following description, given solely by way of example, and referring to the appended drawings given as non-limiting examples, wherein identical references are given to similar objects and wherein:

FIG. 1 is a schematic elevation view of an example of a spraying system in action in an orchard, with six spraying columns, and 24 spraying nozzles;

FIG. 2 shows an example of a hydraulic diagram of the spraying system according to a generic embodiment of the present invention:

FIG. 3 schematically shows an example of a spraying unit with a local pneumatically operated valve of the normally closed type:

FIG. 4 illustrates the pneumatic circuit diagram associated with the example of a spraying unit shown in FIG. 3:

FIG. 5 schematically shows an example of a spraying unit with a local pneumatically operated valve of the normally open type:

FIG. 6 illustrates the pneumatic circuit diagram associated with the example of a spraying unit shown in FIG. 5:

FIG. 7 shows a chronogram illustrating an example of spraying interruption and

purging in the system shown in FIG. 4;

FIG. 8 shows a chronogram illustrating an example of spraying interruption and purging in the system shown in FIG. 6;

FIG. 9 schematically shows another example of a spraying unit, in a simplified version, the liquid delivery control valve being located remotely.

It should be noted that the figures set out the invention in detail to enable the implementation of the invention: although not limiting, said figures serve notably to better define the invention if necessary. For clarity of the presentation, some elements are not necessarily represented to scale.

### DETAILED DESCRIPTION

The invention relates to a product spraying system in liquid form, the product being intended to be projected in the form of droplets on a target vegetation denoted TV. The product to be sprayed can be a phytosanitary product or a liquid fertilizer.

In large-scale farming operations, the target vegetation will typically be cereals, protein crops, legumes, oilseeds, etc. In viticultural or arboricultural operations, the target vegetation will typically be tree or shrub foliage or vineyard foliage. It is noted that the target vegetation can be any in the sense of the present invention.

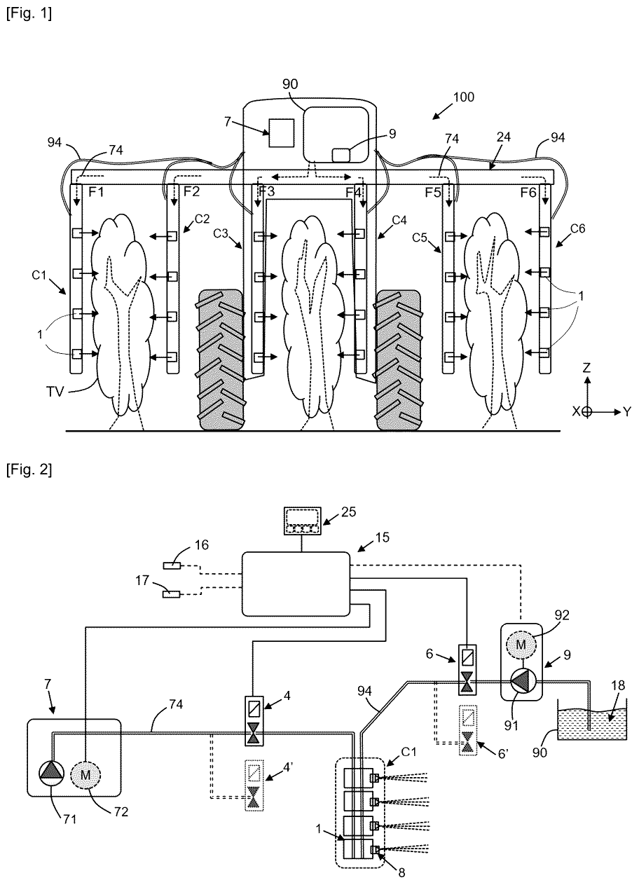

The spraying system can be associated with an agricultural vehicle of the straddle-type tractor as in FIG. 1, or with a conventional tractor. In another application case, the spraying system is associated with an agricultural vehicle towed by a tractor.

By convention, the direction of advancement of the agricultural vehicle is designated by the reference X forming the so-called longitudinal axis, the direction transverse to the longitudinal movement by the reference Y, and the vertical direction by the reference Z.

According to the example illustrated in FIG. 1, the spraying system can comprise a plurality of treatment assemblies, generally arranged in pairs, each pair being intended to treat a row of vegetation. For example, the system can comprise two treatment assemblies to treat one row of vegetation or four treatment assemblies to treat two rows of vegetation, or six treatment assemblies to treat three rows of vegetation as illustrated, and so on.

According to the example illustrated in FIG. 1, the spraying system comprises six spraying columns, respectively designated C1, C2, C3, C4, C5, and C6. The spraying columns are supported by a structural crosspiece denoted 24. Each spraying column comprises four nozzles in the illustrated example.

Each of the columns can form a pneumatically commanded section selectively via the respective pneumatic lines F1, F2, F3, F4, F5, and F6.

According to the example illustrated in FIG. 1, in the usage configuration, the treatment assemblies extend substantially in a vertical position to a height ideally corresponding to the height of the vegetation to be treated. The direction of product spraying extends substantially horizontally.

In the treatment configuration, as visible in FIG. 1, two spraying columns frame a row of vegetation TV or, in other words, a row of vegetation is interposed between two spraying columns located opposite each other, and which spray treatment product towards the vegetation.

According to various embodiments, the configuration and geometric arrangement of the nozzles can be different. The nozzles can be grouped by groups or subsets according to the logic of application of the treatment product and the vegetation to be treated. In other words, several sections or several parts are provided that can be activated or deactivated independently of each other.

For example, in a large-scale farming context, not represented in the figures but very widespread, horizontal booms (i.e., long horizontal arms) are provided in the usage configuration with nozzles that project the treatment product downwards. The booms can be of the telescopic type and can extend in the usage configuration over a long length. In certain operational conditions, it may be necessary to inhibit part of the nozzles to avoid spraying inappropriately.

Each spraying column C1-C6 comprises a plurality of spraying nozzles 8. The spraying nozzles 8 are arranged one after the other in a vertical direction in a spraying configuration, with an inter-nozzle spacing of about 20 or 30 centimeters, for example. Depending on the type of vegetation to be treated, the number of nozzles per column can range, for example, from three to 10.

Each spraying nozzle 8 is comprised in an entity called a spraying unit and designated 1.

In a generic way, the spraying system comprises a pumping unit denoted 9 to pump the treatment product from a product tank 90 forming a reservoir for the treatment liquid 18.

The pumping unit 9 comprises a pump 91 and a motor 92 configured to drive the pump in rotation. The motor 92 can be an electric motor or a hydraulic motor.

Liquid pipelines collectively designated by the reference 94 are provided to convey the liquid under pressure to the spraying nozzles.

The proposed spraying system comprises an electropneumatic group 7. The electropneumatic group 7 comprises a compressor 71 driven by a motor 72 configured to drive the compressor. The motor 72 can be an electric motor or a hydraulic motor (in which case the electropneumatic group is a hydropneumatic group).

The electropneumatic group 7 may further include one or more solenoid valves that will be discussed later. The solenoid valves can be integrated into the electropneumatic group or can be located remotely from the electropneumatic group.

Pneumatic lines collectively designated by the reference 74 are provided to convey compressed air to the spraying units 1, via, if necessary, one or more pneumatic or electropneumatic valves that will be discussed later.

FIG. 2 schematically illustrates the hydraulic and pneumatic system used in the spraying system.

The spraying system comprises a control unit designated 15, in charge in the illustrated example of commanding the compressor motor and the liquid pump motor. A control panel 25 or equivalent is provided, allowing an operator to trigger the start or stop of a spraying sequence. If necessary, the control panel 25 makes it possible to define groups or subsets of nozzles to be inhibited punctually or temporarily, and to command the corresponding pneumatic solenoid valves accordingly.

Furthermore, for the operation of the control unit, various sensors 16 and/or push buttons 17 are provided, for example, pressure sensors, temperature sensors, level sensors, activation buttons, start/stop buttons, as known in themselves, therefore not described in detail here.

In FIG. 2, only one spraying column C1 is shown, which is supplied on the one hand by a liquid pipeline 94, and on the other hand by one or two pneumatic lines 74, according to several possible embodiments that will be seen below.

A pneumatic solenoid valve 4 is provided to supply the spraying column with compressed air. It is noted that another or several other pneumatic solenoid valves 4′ can be provided in parallel to supply other spraying columns.

A valve 6 is provided to supply the spraying column with treatment liquid. It is noted that another or several other valves 6′ can be provided in parallel to supply other spraying columns with treatment liquid.

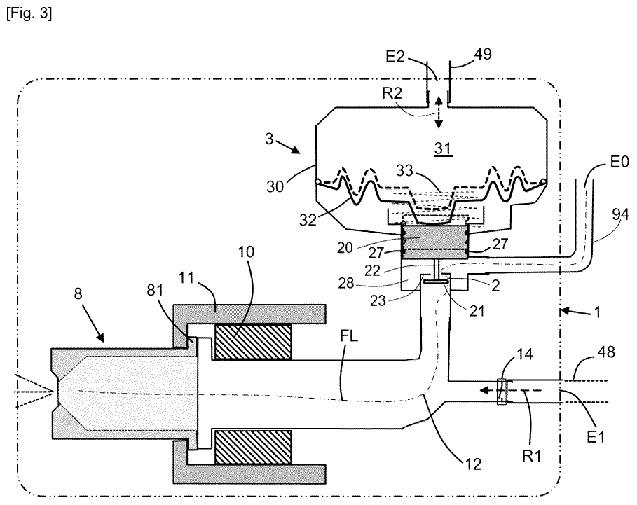

In reference to FIG. 3, the spraying unit 1 comprises a spraying nozzle 8 and a pneumatically operated valve 3 that allows the treatment liquid to be selectively sent under pressure to the nozzle or not.

Furthermore, the spraying unit 1 comprises a liquid inlet designated E0, and a delivery channel 12 extending from the liquid inlet to the nozzle through an obstructable passage 2.

In this first embodiment, the pneumatically operated valve 3 is of the normally closed type.

The spraying unit 1 comprises a first pneumatic inlet E1 that will be discussed later.

The pneumatically operated valve 3 comprises a pneumatic chamber 31 (‘lung’) delimited by a membrane 32 and a valve body 30. The valve body can be, for example, generally cylindrical. The membrane 32 is presented as a flexible disk, anchored at its peripheral edge on the valve body.

The pneumatic chamber 31 is in fluid communication with a second pneumatic inlet E2 from the compressed air line 49 that arrives at the spraying unit.

In other words, the pneumatically operated valve is supplied by the second pneumatic inlet E2.

In the illustrated example, a piston 20 with one or two peripheral O-rings 27 is provided. The piston 20 separates the pneumatic part (above) from the hydraulic part (below). The central area of the flexible membrane is connected to the piston 20. Thus, the piston 20 is driven in its vertical sliding movement by the flexible membrane 32.

At the base of the valve, an obstructable passage 2 is provided, with a valve 21 and a valve seat 23. More precisely, a control rod 22 is fixed on the one hand to the piston 20 and on the other hand to the center of the valve 21, the rod 22 passes through the valve seat 23, which is annular in shape.

The flexible membrane 3 is urged upwards against the pneumatic pressure by means of a helical spring 33. The flexible membrane 3 drives with its movement the piston 20 and the valve 21.

Thus, when the pneumatic chamber is not pressurized, i.e., is not supplied with compressed air, the flexible membrane 32 and the piston are returned upwards by the return spring 33, and the valve 21 is pressed against the valve seat 23, thus obstructing the obstructable passage.

Conversely, when the pneumatic chamber is supplied with compressed air, the flexible membrane 32 is moved downwards by the pneumatic pressure against the spring (which is then compressed), the piston 20 is moved downwards, and the passage between the valve 21 and the valve seat 23 is released. A liquid flow denoted FL is then established from the liquid inlet E0 to the delivery channel 12 and then to the spraying nozzle 8. The liquid then passes from the annular chamber 28 located around the rod 22 through the open valve seat and towards the nozzle 8.

In other words, the central area of the flexible membrane is movable between a first position causing the obstruction of the obstructable passage 2 (state represented in dashed lines in FIG. 3) and a second position causing the release of said obstructable passage (state represented in solid lines).

Alternatively, the return spring 33 could be placed under the piston, in the liquid compartment, and could then push the piston upwards.

Furthermore, the first pneumatic inlet E1 of the spraying unit, already mentioned, is connected to the delivery channel 12. A tapping is provided in the spraying unit for the arrival of blowing air.

Advantageously, the first pneumatic inlet E1 is connected to the delivery channel via a check valve 14.

The check valve 14 allows air to pass from the first pneumatic inlet E1 to the delivery channel but prevents liquid in the delivery channel 12 from flowing back to the first pneumatic inlet E1.

According to one embodiment, the check valve 14 comprises a valve-forming member movable between a closed position wherein this member is pressed against a valve seat and an open position wherein the valve-forming member is away from the valve seat. It is also possible to use a check valve in the form of a ball received in a conical seat and returned by a small return spring.

The check valve 14 can be calibrated to open under a pressure difference between 500 millibars and 2 bars on the side of the first pneumatic inlet E1.

It is noted that the air flow passing through the check valve, denoted R1, is unidirectional, while the air flow R2 prevailing at the second inlet E2 is bidirectional. The air flow R2 is incoming to inflate the pneumatic chamber and is expelled (outgoing) in the opposite direction when the chamber sees its pressure decrease.

Furthermore, the spraying unit 1 comprises a unit body 10 forming a structure on which the nozzle 8 is fixed. The pneumatically operated valve 3 is also fixed to the unit body 10. The unit body 10 can comprise fixing brackets or other accessory elements.

A flange 11 is provided that clamps a collar 81 belonging to the nozzle to hold the nozzle on the unit body 10. The nozzle is thus replaceable if necessary.

In the illustrated example, the delivery channel 12 is formed directly in the unit body 10.

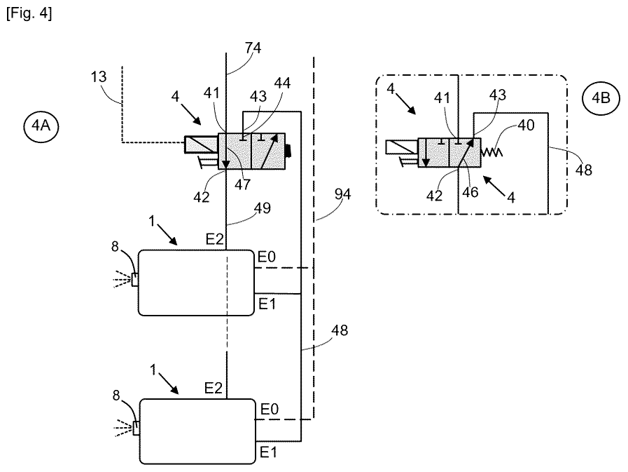

FIG. 4 shows the liquid and pneumatic circuits serving two spraying units.

The pneumatic solenoid valve 4 receives an electrical command from the control unit 15 via the command line 13.

The pneumatic solenoid valve comprises a movable spool, also called a core, which is moved inside a cylindrical solenoid valve body, as known in itself, under the effect of a force generated by an electromagnetic force induced by the current passing through the coil and under the effect of an opposing force provided by a return spring 40.

Ports are provided on the cylindrical body that receives the spool.

A first port 41 receives compressed air from the pneumatic compressor 71 via the line 74. A second port 42 forms the outlet to the spraying units, more precisely the pneumatic chambers 31 via the line 49. A third port 43, which normally corresponds to the vent to the open air, is here cleverly connected to the first pneumatic inlets E1 of the spraying units, via a diversion line designated 48.

The pneumatic solenoid valve 4 is of the 3/2-type (two positions, three ports).

The part noted 4A shown in FIG. 4 represents the solenoid valve in its state of having been activated by the coil, while the part denoted 4B represents the solenoid valve in an inactive state, i.e., at rest under the effect of the return spring.

In the activated state, the orifice 47 of the core communicates the first port 41 with the second port 42 and supplies compressed air to the pneumatic chamber 31 via the line 49 and the second air inlet E2.

In the inactive state at rest, the orifice 46 of the core communicates the second port 42 with the third port 43 and the diversion line designated 48.

The volume of air that was stored in the pneumatic chamber 31 is therefore not vented to the open air but redirected to the first inlet E1 of the spraying unit to push the liquid in the delivery channel 12 out through the nozzle orifice.

The volume of air stored in the pneumatic chamber 31 represents a sufficient air reserve to purge the delivery channel 12.

In other words, by means of the diversion line 48, an air supply via the first pneumatic inlet E1, when the obstructable passage is obstructed, allows the delivery channel 12 and the nozzle 8 to be purged.

It is noted that when the pneumatic solenoid valve 4 is activated, the third port 43 is in front of a closed wall (represented by a dead end 44), thus isolating the diversion line 48, which remains protected from any external pollution.

FIG. 7 illustrates a sequence chronogram of spraying interruption on a spraying unit. The pressure PR1 is the pressure prevailing in the first pneumatic inlet E1. The pressure PR2 is the pressure prevailing in the second pneumatic inlet E2 and in the pneumatic chamber 31.

At time t1, the electrical command 45 of the solenoid valve 4 switches from On to Off. The spool is then returned to its rest position by the spring 40. The air supply from the compressor is stopped. The air that was contained in the lung flows through the diversion line 48 to the first pneumatic inlets E1 of the spraying units. We then have PR2=PR1.

At time t2, the majority of the liquid that was contained in the delivery channel 12 has been expelled by the nozzle, and the air can directly exit through the nozzle orifice, which causes the air pressure to drop rapidly, tending towards 0.

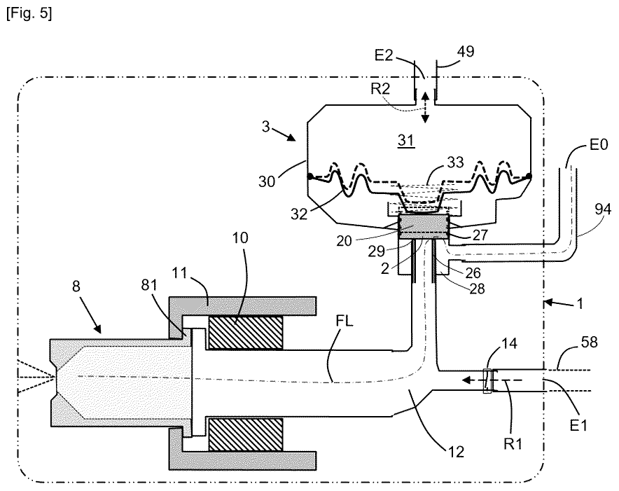

In reference to a second embodiment represented in FIG. 5, the spraying unit 1 comprises a spraying nozzle 8 and a pneumatically operated valve 3 that is of the normally open type, contrary to the configuration illustrated in FIG. 3.

The elements not described again here are identical or similar to those described with reference to FIG. 3.

As previously, the pneumatic solenoid valve 4 commands the pneumatically operated valve 3, according to the logic already set out, with the opposite effect on the obstructable passage. When the pneumatic solenoid valve 4 is excited, the passage 2 is closed, whereas when the pneumatic solenoid valve 4 is at rest, the passage 2 is open.

However, this pneumatic solenoid valve is not used for air blowing for nozzle purging purposes: another solenoid valve, specific to nozzle purging, designated 5, is provided for this.

When the pneumatic chamber is not pressurized, i.e., is not supplied with compressed air, the flexible membrane 32 is returned upwards by the return spring 33. The piston is also returned upwards. The obstructable passage 2 is then open. A liquid flow denoted FL is then established from the liquid inlet E0 to the delivery channel 12. The liquid flow FL passes from the outside to the inside of the line 26.

Conversely, when the pneumatic chamber is supplied with compressed air, the flexible membrane 32 is moved downwards by the pneumatic pressure against the spring (which is then compressed). In this position, the central area of the membrane pushes the piston 20, which comes to press against an annular seat 29, and consequently comes to obstruct the obstructable passage 2. The liquid flow FL is then interrupted.

It is therefore the piston 20 that acts as a valve, under the effect of the movements imparted to the flexible membrane 3 by the pressure prevailing in the pneumatic chamber 31.

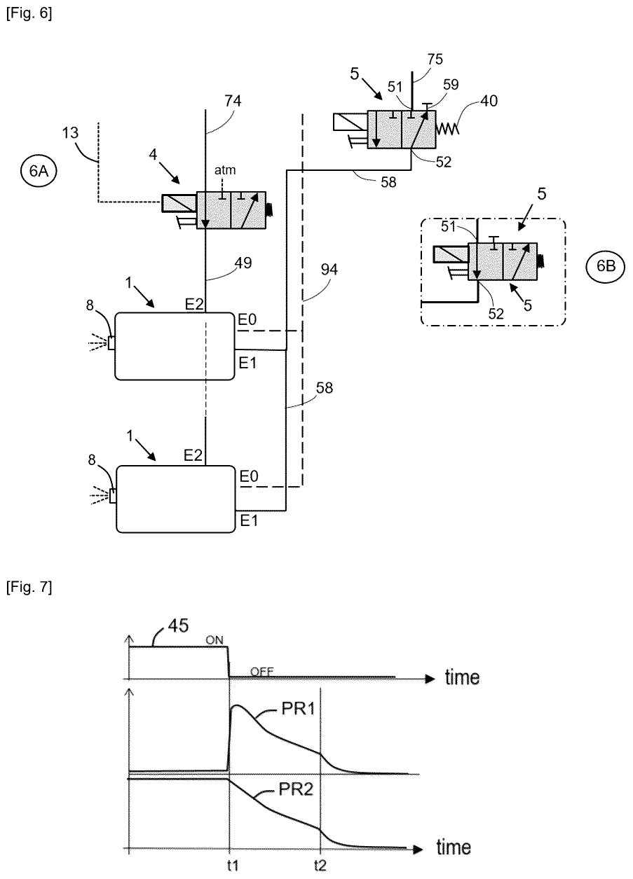

FIG. 6 shows the function of the specific solenoid valve 5 acting on the purge.

The part noted 6A of FIG. 6 represents the specific solenoid valve 5 in an inactive state, i.e., at rest under the effect of the return spring, while the part denoted 6B represents the specific solenoid valve 5 in its activated state by the coil.

Ports are provided on the cylindrical body that receives the spool. A first port 51 receives compressed air from the compressed air line 75. A second port 52 forms the outlet to the first pneumatic inlets E1 of the spraying units, via the air line 58.

Normally, the specific solenoid valve 5 is not supplied, and its second port 52 is connected to a closed wall 59, to preserve the integrity and cleanliness of the supply lines 58 of the first pneumatic inlets E1.

The specific solenoid valve 5 is only commanded when there is a need to purge the delivery channel and the drop from the nozzle orifice.

When the specific solenoid valve 5 is excited or activated (sketch 6B), the first port 51 is put in fluid communication with the second port 52, and compressed air is directed from the compressed air line 75 to the supply lines of the first pneumatic inlets E1 via the air line 58 to purge the delivery channel and the nozzle.

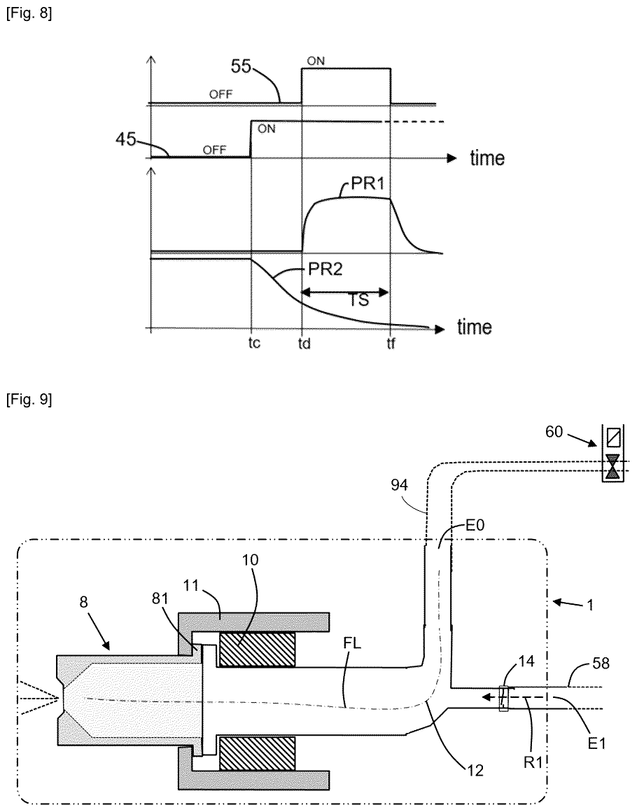

In FIG. 8, the signal 55 corresponds to the excitation of the specific solenoid valve 5.

The moment the corresponds to the interruption of the command on the pneumatic solenoid valve 4 controlling the lung 31 of the pneumatic valve 3. The pressure PR2 in the chamber 31 decreases from this moment.

The moment td corresponds to the start of the blowing sequence, the moment when the specific solenoid valve 5 is commanded by the signal 55 and switches to the activated state (from OFF to ON).

The pressure PR1 increases sharply until the moment tf when the specific solenoid valve 5 is deactivated and returns to the rest state (from ON to OFF). The blowing duration denoted TS (see FIG. 8) can be advantageously parameterizable in the control unit 15.

FIG. 9 shows another example of a spraying unit 1, devoid of a local valve for liquid distribution. The valve that authorizes the passage of fluid or interrupts the delivery of fluid, denoted 60, is located remotely, for example, in the common manifold of a distribution section.

For the rest, the spraying unit 1 is identical or similar, mutatis mutandis, to what has been described previously concerning FIGS. 5 and 6, but without the presence of a local command valve, the inlet E0 is in permanent communication with the delivery channel 12.

Considering the normally open-type solution represented in FIGS. 5 and 6, the invention also covers, mutatis mutandis, the case of an electrically operated valve instead of a pneumatically operated valve.

In general, the pneumatically operated valve 3 could be different from that represented in FIGS. 3 and 5: other types of pneumatically operated valves can be used, notably with rigid pistons and connecting rods.

Similarly, the liquid chamber inside the spraying unit could be different from that represented.

It is also noted that the invention is not limited to the embodiments described above. It will indeed appear to the person skilled in the art that various modifications can be made to the embodiments described above, in light of the teaching that has just been disclosed to said person.

In the detailed presentation of the invention made above, the terms used should not be interpreted as limiting the invention to the embodiment exposed in the present description, but should be interpreted to include all equivalents whose provision is within the reach of the person skilled in the art by applying their general knowledge to the implementation of the teaching that has just been disclosed to them.

1. A spraying unit selective of liquid comprising a liquid inlet, a spraying nozzle, a delivery channel extending from the liquid inlet to the spraying nozzle, characterized in that the spraying unit comprises a first pneumatic inlet connected to the delivery channel via a check valve, so that an air supply via the first pneumatic inlet, when the liquid inlet no longer delivers liquid, allows the delivery channel and the nozzle to be purged, and in that said delivery channel extends from the liquid inlet to the spraying nozzle through an obstructable passage, a pneumatically operated valve with a pneumatic chamber delimited by a membrane and supplied by a second pneumatic inlet, the membrane being movable between a first position causing the obstruction of the obstructable passage and a second position causing the release of said obstructable passage, so that an air supply via the first pneumatic inlet, when the obstructable passage is obstructed, allows the delivery channel and the nozzle to be purged.

2. The spraying unit according to claim 1, wherein the pneumatically operated valve is of the normally closed type.

3. The spraying unit according to claim 1, wherein the pneumatically operated valve is of the normally open type.

4. The spraying unit according to claim 1, further comprising a unit body forming a structure on which the nozzle and the pneumatically operated valve are fixed.

5. The spraying unit according to claim 1, wherein the delivery channel is arranged and formed in the unit body.

6. A spraying system comprising a plurality of spraying units according to claim 1, and at least one pneumatic solenoid valve selectively supplying compressed air to the first pneumatic inlets of the spraying units.

7. The spraying system according to claim 6, wherein the pneumatic solenoid valve is a 3/2 pneumatic solenoid valve with the purge orifice connected to the first pneumatic inlets of the spraying units.

8. The spraying system according to claim 6, wherein the pneumatic solenoid valve is a specific pneumatic solenoid valve.

9. The spraying system according to claim 6, comprising several spraying units functionally arranged in parallel by groups or subsets.

10. The spraying system according to claim 6, comprising at least one delivery valve for the treatment product.
